(19) United States
(12) Patent Application Publication
(10) Pub. No.: US 2008/0190016 A1
(43) Pub. Date: Aug. 14, 2008

(54) Device for and Method of Delivering Superheated Liquid and Gas for Biocidal Treatment

(76) Inventor: John Burton, Osborne Park (AU)

Correspondence Address: DORITY & MANNING, P.A., POST OFFICE BOX 1449, GREENVILLE, SC, 29602-1449, US

(21) Appl. No.: 11/909,172

(22) PCT Filed: Mar. 20, 2006
(86) PCT No.: PCT/AU2006/000368

§ 371 Date: Jan. 25, 2008

(30) Foreign Application Priority Data
Mar. 21, 2005 (AU) 2005901364

(51) Int. Cl. A01M 21/04; A01M 19/00; A01M 7/00

(52) U.S. Cl. 47/1.5; 47/58.1 R; 15/321; 137/334

(57) ABSTRACT

A device (10) is disclosed for biocidal treatment of vegetation and/or pests, the device (10) comprising an inner tube (30) connectable to a source of one of heated pressurised gas and heated pressurised water, an outer tube (26) disposed over the inner tube so that a space is defined between the inner tube and the outer tube, and a wand (22) in communication with the inner tube (30) and the outer tube (26). The wand (22) has an outlet aperture and the outer tube (26) is connectable to a source of the other of heated pressurised gas and heated pressurised water. The heated air and water mix in the wand (22) immediately prior to passing through the outlet aperture.

### FIELD OF INVENTION

The present invention relates to a device for and method of delivering superheated liquid and gas such as water and air, in particular for biocidal treatment of vegetation and/or pests.

### BACKGROUND OF THE INVENTION

It is known to effect vegetation and pest control by direct application of heat including the application, at elevated temperatures, of water, foam and/or air, or application of flames.

Traditionally, the delivery of pressurised superheated water and air for the biocidal treatment of vegetation and pests has been through the use of separate tubes joined at an application wand. However, this method results in the tubes and associated insulative and protective layers being heavy to use when connected to the wand. In addition, since the air is conveyed into the wand typically using a 20 metre hose, the air is often at or close to ambient temperature even if the air has been heated prior to entering the tube due to a heat exchange effect between the air hose and the outside ambient air temperature. The traditional hose arrangement described above is also inconvenient to attach and detach from the heating equipment since attachment and detachment requires the use of spanners.

### SUMMARY OF THE INVENTION

The inventor of the present invention has discovered that the temperature of air at the wand of a biocidal treatment device is critical to the extent that a reduction in the air temperature at the wand dramatically alters the effectiveness of the biocidal treatment.

In accordance with a first aspect of the present invention, there is provided a device for biocidal treatment of vegetation and/or pests, the device comprising:
an inner tube connectable to a source of one of heated pressurised gas and heated pressurised water;
an outer tube disposed over the inner tube so that a space is defined between the inner tube and the outer tube, the outer tube being connectable to a source of the other of heated pressurised gas and heated pressurised water; and
a wand in communication with the inner tube and the outer tube, the wand having an outlet aperture;
wherein the heated air and water mix in the wand immediately prior to passing through the outlet aperture.

In this way, since the inner tube carrying one of air and water is disposed inside the outer tube carrying the other of air and water, the temperature of the air and water at the wand remains relatively high. In addition, cumbersome tube arrangements are avoided.

The outer tube may form part of a manifold, the outer tube and the inner tube defining a first annular space and the manifold comprising a branch tube in fluid communication with the first annular space.

In one arrangement, the device further comprises a flexible hose extending from the inner and outer tubes to the wand, the inner tube extending through the hose to the wand, and the inner tube and the hose defining a second annular space in fluid communication with the first annular space.

The device may further comprise a first quick release connection associated with heated air to be dispensed by the device and a second quick release connection associated with heated water to be dispensed by the device, the first and second connections being connectable to a source of pressurised heated air and water.

The inner tube may formed of Teflon material.

In one arrangement, the device further comprises insulation disposed around at least part of the outer tube, and/or the wand.

In one arrangement, the device further comprises insulation disposed around at least part of the hose.

In accordance with a first aspect of the present invention, there is provided a method of biocidally treating vegetation and/or pests, the method comprising:
providing an inner tube;
connecting the inner tube to a source of one of heated pressurised gas and heated pressurised water;
providing an outer tube over the inner tube so that a space is defined between the inner tube and the outer tube;
connecting the outer tube to a source of the other of heated pressurised gas and heated pressurised water;
providing a wand in communication with the inner tube and the outer tube, the wand having an outlet aperture; and
mixing heated air and water in the wand immediately prior to passing through the outlet aperture.

### DESCRIPTION OF THE DRAWINGS

The present invention will now be described, by way of example only, with reference to the accompanying drawings, in which:

FIG. 1 is a cross sectional view of a device for delivering superheated liquid and gas for biocidal treatment in accordance with an embodiment of the present invention; and

FIG. 2 is a cross-sectional view of a manifold of the device shown in FIG. 1.

### DETAILED DESCRIPTION OF AN EMBODIMENT OF THE INVENTION

Referring to the drawings, there is shown a device 10 for delivering superheated liquid and air for biocidal treatment.

In the present example, the device 10 is used for delivering superheated water and air for biocidal treatment, although it will be understood that other gases and liquids may be used, the important aspect being that when the liquid and gas are heated to a sufficient temperature, the liquid and gas are capable of biocidally treating vegetation and pests.

The device 10 is connectable to a suitable source of gas and liquid, in this example a source 12 of heated pressurised air and pressurised superheated water. For this purpose, the source 12 includes an air outlet 14 and a water outlet 16. In this example, the air and water outlets 14, 16 are of quick-release type so as to enable the device 10 to be selectively easily released from engagement with the source 12. However, it will be understood that other connection arrangements are envisaged.

The device 10 includes a manifold 18 releasably connectable to the source 12 of the pressurised heated air and pressurised superheated water, a flexible hose 20, in this example formed of heat resistant rubber material, and a wand 22 provided with a nozzle 24.

The manifold 18 in this example is formed of stainless steel material, although it will be understood that any suitable heat resistant relatively strong material is envisaged.

The manifold 18 includes an outer tube 26 integral with a branch tube 28. Extending through the outer tube 26 is an inner tube 30, in this example formed of heat resistant material with a low coefficient of expansion, such as Teflon tubing.

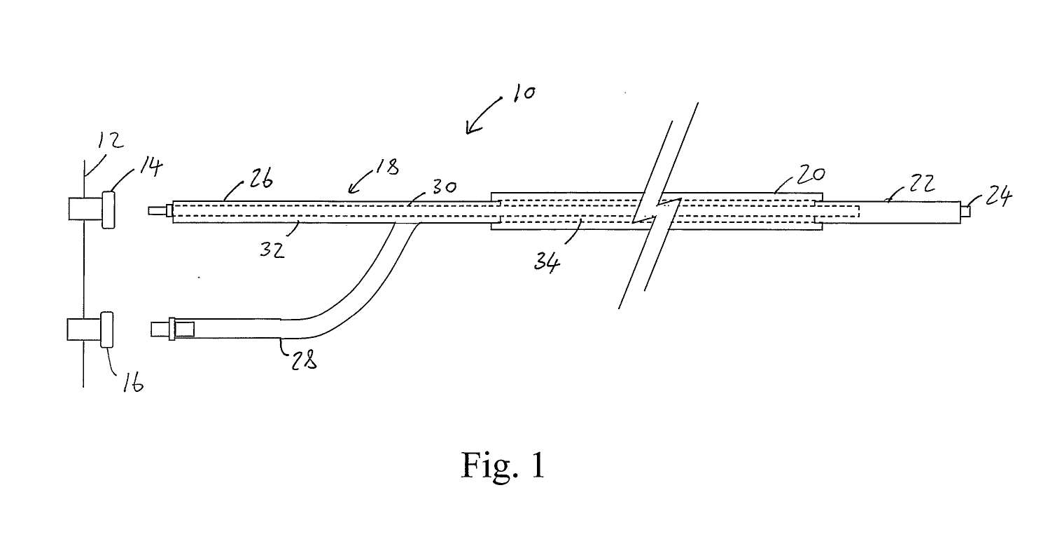

As can be seen in FIG. 1, the inner tube 30 also extends through the hose 20 and into the wand 22, an end of the inner tube 30 opening into the wand 22. The outer tube 26 and the inner tube 30 define a first annular space 32 in fluid communication with the branch tube 28. Likewise, the hose 20 and the inner tube 30 define a second annular space 34 in fluid communication with the first annular space 32. The second annular space 34 is in fluid communication with the wand 22.

The wand 22 may be formed of any suitably strong heat resistant material, in this example aluminium.

During use, when the device 10 is engaged with the source 12 of pressurised heated air and pressurised superheated water, pressurised heated air flows through the inner tube 30 and thereby directly into the wand 22. At the same time, pressurised superheated water flows through the branch tube 28, the first and second annular spaces 32, 34 and into the wand 22.

It will be understood that the pressurised air and pressurised superheated water are kept separate by the device 10 until the air and water reach the wand 22. At the wand 22, the air and water mix and are ejected from the nozzle 24.

The pressurised air and water mix in the application wand before exiting the wand under pressure and at an ideal velocity of around 60 kmh to take advantage of the wind chill effect.

The aluminum wand may have an insulation layer with a PVC outer casing to stop heat loss and to protect the human operator from the heat of the application wand.

It will be understood that by ensuring that the air and water do not mix until immediately prior to ejection from the wand 22, the temperature of the ejected air and water can be maintained relatively high and thereby the efficiency of the biocidal treatment device maintained relatively high.

It will also be appreciated that since the inner tube 30 which carries the heated pressurised air is disposed inside the outer tube 26 and hose 30 which carry the pressurised superheated water, the temperature of the air at the wand 22 can be maintained relatively high and thereby the efficiency of the biocidal treatment device maintained relatively high.

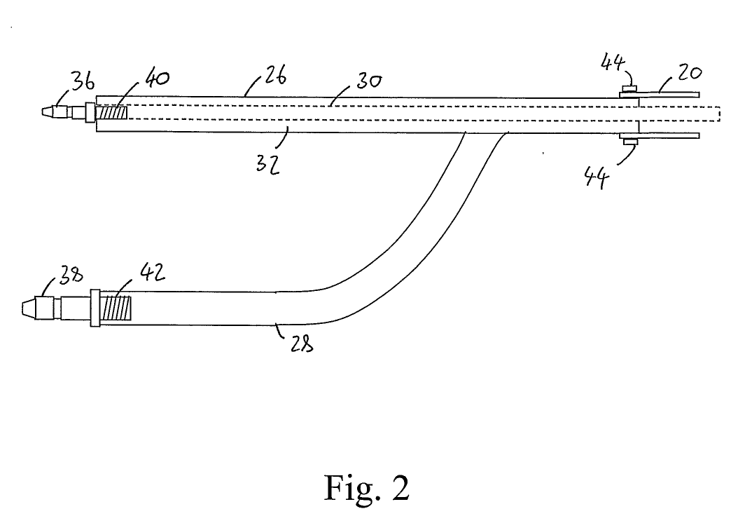

As shown more particularly in FIG. 2, the outer and branch tubes 26, 28 of the manifold 18 are provided with first and second quick release couplings 36 and 38 respectively, the first and second quick release couplings 36, 38 being connected to the outer and branch tubes 26, 28 using first and second screw threaded portions 40 and 42 respectively.

The hose 20 may be fixed to the outer tube 26 in any suitable way, for example using a clamp 44.

The tubes and/or hose of the device described may be protected with an appropriate insulation layer. Disposed over the hose insulation layer may be a neoprene jacket and a nylon spiral wrap to protect against abrasion when dragging the hose on the ground.

While the above embodiment is described in relation to a device wherein heated pressurized air flows through the inner tube and heated pressurized water flows through the annular space between the inner tube and the outer tube, it will be understood that as an alternative, heated pressurized water may flow through the inner tube and heated pressurized air may flow through the annular space between the inner tube and the outer tube.

Modifications and variations as would be apparent to a skilled addressee are deemed to be within the scope of the present invention.

1. A device for biocidal treatment of vegetation and/or pests, the device comprising:
an inner tube connectable to a source of one of heated pressurised gas and heated pressurised water;
an outer tube disposed over the inner tube so that a space is defined between the inner tube and the outer tube, the outer tube being connectable to a source of the other of heated pressurised gas and heated pressurised water; and
a wand in communication with the inner tube and the outer tube, the wand having an outlet aperture;
wherein the heated air and water mix in the wand immediately prior to passing through the outlet aperture.

2. A device as claimed in claim 1, wherein the outer tube forms part of a manifold, the outer tube and the inner tube defining a first annular space and the manifold comprising a branch tube in fluid communication with the first annular space.

3. A device as claimed in claim 1, further comprising a flexible hose extending from the inner and outer tubes to the wand, the inner tube extending through the hose to the wand, and the inner tube and the hose defining a second annular space in fluid communication with the first annular space.

4. A device as claimed in claim 1, further comprising a first quick release connection associated with heated air to be dispensed by the device and a second quick release connection associated with heated water to be dispensed by the device, the first and second connections being connectable to a source of pressurised heated air and water.

5. A device as claimed in claim 1, wherein the inner tube is formed of Teflon material.

6. A device as claimed in claim 1, further comprising insulation disposed around at least part of the outer tube, and/or the wand.

7. A device as claimed in claim 3, further comprising insulation disposed around at least part of the hose.

8. A method of biocidally treating vegetation and/or pests, the method comprising:
providing an inner tube;
connecting the inner tube to a source of one of heated pressurised gas and heated pressurised water;
providing an outer tube over the inner tube so that a space is defined between the inner tube and the outer tube;
connecting the outer tube to a source of the other of heated pressurised gas and heated pressurised water;
providing a wand in communication with the inner tube and the outer tube, the wand having an outlet aperture; and
mixing heated air and water in the wand immediately prior to passing through the outlet aperture.
